(19) United States
(12) Patent Application Publication
(10) Pub. No.: US 2024/0397932 A1
(43) Pub. Date: Dec. 5, 2024

(54) PORTABLE INSECT REPELLING DEVICE

(71) Applicant: PIC Corporation, Linden, NJ (US)

(72) Inventors: Eric Rubel, Westfield, NJ (US); David L. Lowe, Port Monmouth, NJ (US); Lawrence E. Bradford, Westfield, NJ (US)

(21) Appl. No.: 18/733,233

(22) Filed: Jun. 4, 2024

Related U.S. Application Data
(60) Provisional application No. 63/471,153, filed on Jun. 5, 2023.

(51) Int. Cl. A01M 29/12

(52) U.S. Cl. CPC A01M 29/12; A01M 2200/01

(57) ABSTRACT

A portable insect repelling vaporizer device including a heating element and removable repellant cartridge that is only activated when the cartridge is in place.

The present application claims benefit of and priority to U.S. Provisional Patent Applicant No. 63/471,153 filed Jun. 5, 2023, entitled PORTABLE INSECT REPELLING VAPORIZER, the entire content of which is hereby incorporated by reference herein.

### BACKGROUND

### Field of the Disclosure

The present invention relates to a portable insect repelling vaporizer device.

### Related

Conventional insect repelling vaporizer devices may utilize a flame to vaporize repellant. Some portable devices utilize a chemical repellant and may be a candle or otherwise utilize a flame to vaporize the repellant material to provide an area of vaporized repellant around the device. The use of open flames results both in inconsistent dispersal of repellant as well as the danger of fire. Further, the use of an open flame limits the environments in which use of the device is safe and prevents the ability to safely move the device from place to place when active. Electric vaporizer devices are commonly plugged into an outlet or other line voltage source. While such devices may be effective, they are limited by their reliance on a line voltage such that they can only be used in certain areas and are also not portable.

Accordingly, it would be beneficial to provide an insect repellant device that avoids these and other problems.

### SUMMARY

It is an object of the present disclosure to provide a portable insect repelling vaporizer device to provide a portable area of insect free vaporized repellant.

A portable insect repelling device in accordance with an embodiment of the present disclosure includes: a body including a top portion and a bottom portion, the top portion including an opening in fluid communication with an interior of the body; the bottom portion including: a bottom wall including a recess formed therein; a cartridge adapter configured to releasably secure a cartridge including insect repellant; a heating element positioned adjacent to the cartridge adapter; a movable cartridge detecting element configured to contact the cartridge when the cartridge is mounted in the recess; a power source electrically connected to the heating element and operable to selectively activate the heating element source, wherein the heating source is activated based on a position of the cartridge detecting element.

In embodiments, the top portion and the bottom portion are integrated.

In embodiments, the top portion includes a top wall and sidewall extending downward therefrom to the bottom wall.

In embodiments, the opening is formed in the top wall.

In embodiments, the opening is formed in the sidewall.

In embodiments, a plurality of slots formed in the sidewall.

In embodiments, the body includes four sides and the sidewalls extend from the top wall to the bottom wall on four sides of the body.

In embodiments, the slots are formed in each sidewall of the four sidewalls.

In embodiments, middle portion is positioned between the upper portion and the lower portion.

In embodiments, the lower portion includes a control circuit configured to selectively activate the heating element.

In embodiments, the device includes at least one contact electrically connected to the control circuit.

In embodiments, the cartridge adapter includes a rod, movably mounted in the bottom portion and movable from a closed position, in which the rod is in contact with the cartridge and the at least one contact and allows an electrical connection between the power source and the heating element and an open position in which the rod is separated from the contact and prevents electrical connection between the power source and the heating element.

In embodiments, the device includes a biasing element mounted in the lower portion and configured to bias the rod in the open position.

In embodiments, the device may include an input device operably connected to the control circuit, wherein the control circuit activates the heating element based on input information provided by the input device.

In embodiment, the device includes an indicator mounted in the body and configured to indicate activation of the heating element.

In embodiments, the cartridge adapter includes a rod, movably mounted in the bottom portion and movable from a closed position, in which the rod is in contact with the cartridge and the at least one contact and allows an electrical connection between the power source and the heating element and an open position in which the rod is separated from the contact and prevents electrical connection between the power source and the heating element and the control circuit activates the heating element based on the input information and position of the rod.

In embodiments, the heating element is positioned adjacent a top of the cartridge and configured to heat repellant from the cartridge to vaporize the repellant.

In embodiments, the device includes a passage formed in the top portion to provide fluid communication from the cartridge to the opening which is formed in a top wall of the top portion to allow vaporized repellant to exit the housing.

In embodiments, the device includes a charging circuit electrically connected to the power source and configured to recharge the power source.

In embodiments, the device includes a charging port configured for connection to an external power source and electrically connected to the charging circuit.

In embodiments, the heating element is ring shaped and configured to receive a wick extending from a top of the cartridge to heat repellant in the wick.

### BRIEF DESCRIPTION OF THE DRAWINGS

The above and related objects, features and advantages of the present disclosure will be more fully understood by reference to the following, detailed description of the preferred, albeit illustrative, embodiments of the present invention when taken in conjunction with the accompanying figures, wherein:

FIG. 1 illustrates a front perspective view of a portable insect repelling vaporizer device in accordance with an embodiment of the present disclosure;

FIG. 1A illustrates a front perspective view of a portable insect repelling vaporizer device in accordance with another embodiment of the present disclosure;

FIG. 2 illustrates a front view of the portable insect repelling vaporizer device of FIG. 1 in accordance with another embodiment of the present disclosure;

FIG. 3 illustrates a bottom view of the portable insect repelling vaporizer device of FIG. 1 in accordance with another embodiment of the present disclosure;

FIG. 4 illustrates a cross-sectional front view of the portable insect repelling vaporizer device of FIG. 1 in accordance with another embodiment of the present disclosure;

FIG. 4A illustrates a cross-sectional front view of the portable insect repelling vaporizer device of FIG. 1A in accordance with another embodiment of the present disclosure; and

FIG. 5 illustrates a cross-sectional side view of the portable insect repelling vaporizer device of FIG. 1 in accordance with another embodiment of the present disclosure.

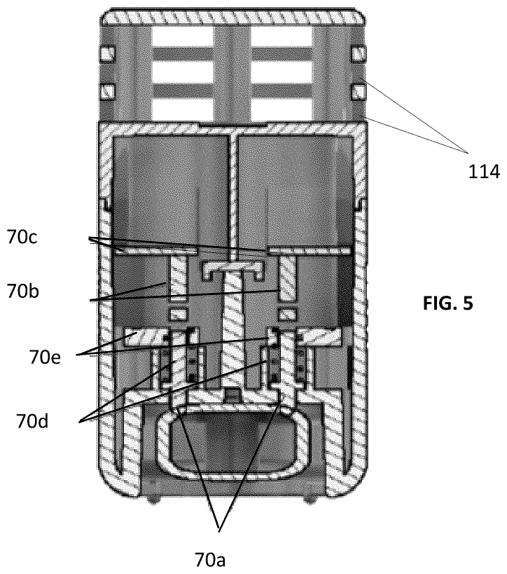

### DETAILED DESCRIPTION OF THE EXEMPLARY EMBODIMENTS

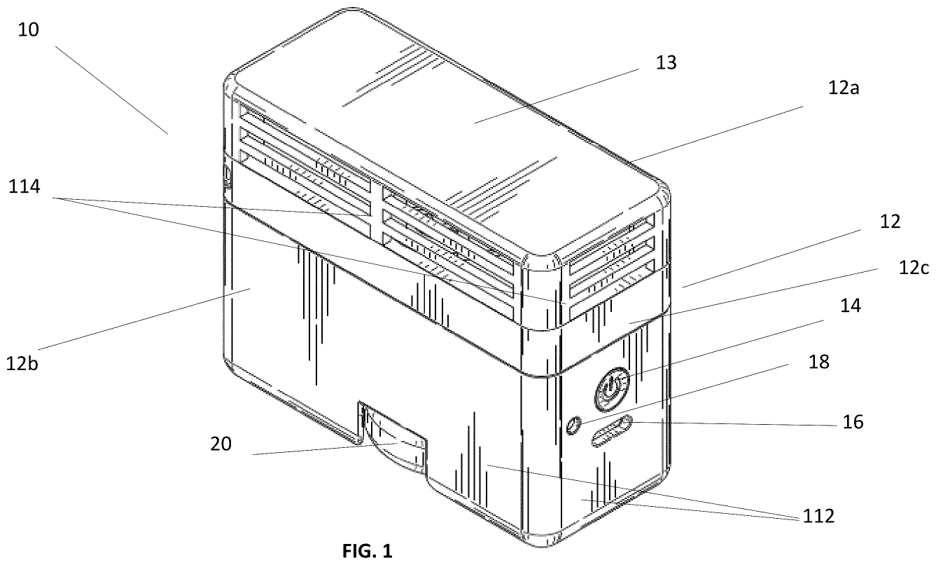

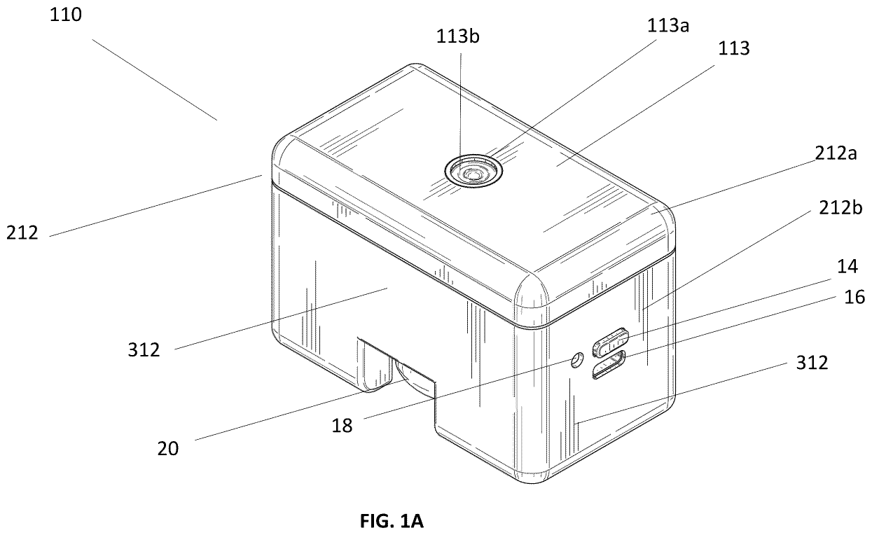

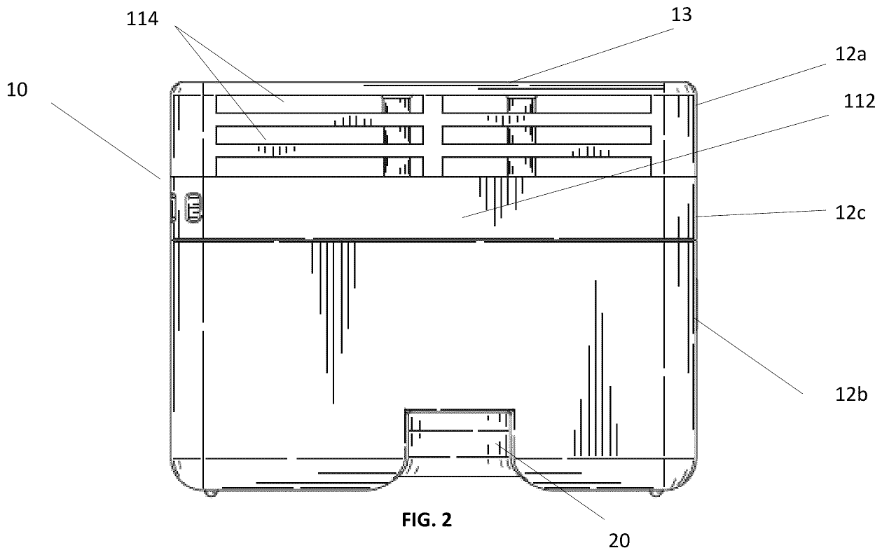

A portable insect repelling vaporizer device 10 in accordance with embodiments of the present disclosure may include a body 12 including a top portion 12a and a bottom portion 12b (see FIGS. 1 and 2, for example). In embodiments, a middle portion 12c may be provided between the top portion 12a and the bottom portion 12b. In embodiments, the body 12 may be integral, that is, a one-piece structure. In embodiments, the top portion 12a and the bottom portion 12b of the body 12 may be permanently connected to each other. In embodiments, the middle portion 12c may be positioned between the top portion 12a and the bottom portion 12c and permanently connected either or both. In embodiments, the top portion 12a, the bottom portion 12b and the middle portion 12c may be integrally formed.

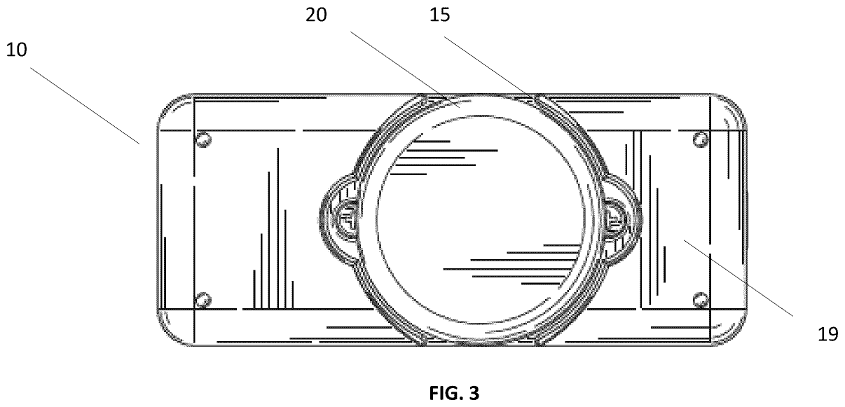

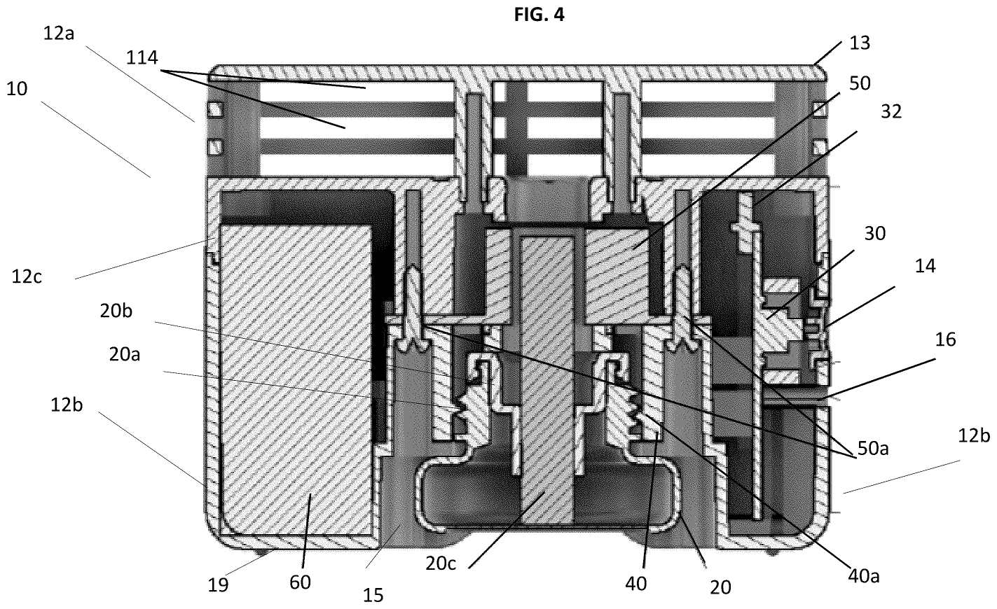

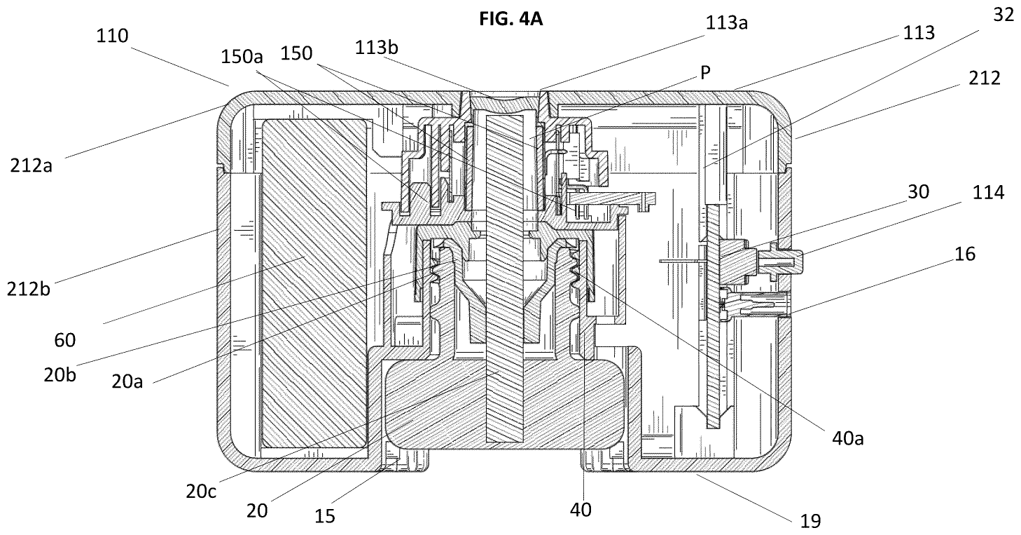

In embodiments, the body 12 may include a top wall 13 with four sidewalls 112 extending downward therefrom. In embodiments, a bottom wall 19 (see FIG. 3, for example) may be provided at the bottom of the four sidewalls 112. In embodiments, the top portion 12a of the body 12, and specifically, the sidewalls 112, may include a plurality of vent slots 114 formed in the sidewalls 112 to allow vaporized material to exit the body 12. In embodiments, a power button 14, or other input element, may be provided in one of the sidewalls 112 to activate and deactivate the device 10. In embodiments, the power button 14 may be provided in the top wall 13, bottom wall 19 or any other portion of the body 12. In embodiments, the power button 14 may be a switch, dial or any other suitable input device and may be of any desired shape. In embodiments, a charging port 16 may be provided in one of the sidewalls 112. In FIGS. 1, 1A, 4 and 4A, the charging port 16 may be provided in a side of the body 12, 212, however, it may be positioned in any portion of the body 12, 212.

In embodiments, a portable insect repelling vaporizer device 110 may include a top wall 113 with at least one opening 113a formed therein as can be seen in FIG. 1A, for example. In embodiments, the body 212 may include only a top portion 212a and a bottom portion 212b which may be permanently connected to each other or integrally formed with each other. In embodiments, the body 212 may be integrally formed. In embodiments, the top portion 212a and bottom portion 212b may be permanently connected to each other. In embodiments, the sidewalls 312 may extend downward from the top wall 113 and may not include the vent slots 114 discussed above. In embodiments, vaporized repellant may exit the body 212 via the opening 113a formed in the top wall 113. In embodiments, the top portion 212a of the body 212 may include an internal passage P (see FIG. 4A, for example) through which vaporized repellant passes to the opening 113a and then through the opening out of the body 212. In embodiments, the opening 113a may include a mesh or screen 113b to limit access to the interior of the body 212 while allowing vaporized repellant to pass through. In embodiments, the mesh or screen 113b may simply be a flange positioned in the opening 113a and limiting passage of the vaporized repellant to a periphery thereof. In embodiments, the mesh or screen 113b is sized and configured to prevent a user from accessing an interior of the body 212.

In embodiments, one or more indicators 18 may be provided in the body 12, 212 (see FIGS. 1 and 1A, for example) and may be configured to indicate when the device 10, 110 is active. In embodiments, the indicator 18 may be a light emitting element, such as a light emitting diode that activates when the device 10, 110 is active, that is, when the device is activated to emit vaporized insect repellant. In embodiments, the indicator 18 may include multiple light emitting elements, which may be light emitting diodes or any other suitable light emitting element. In embodiments, the indicator 18 may include light emitting elements of different colors and the indicator emits one color when the device 10, 110 is active and another color when the device 10 is inactive. In embodiments, the indicator 18 may emit another color when a power source 60, discussed below, is charging.

In embodiments, a bottom wall 19 of the body 12, 212 may include a recess 15 (see FIGS. 3, 4 and 4A, for example) configured to receive a cartridge 20 that may include a quantity of insect repellent. The cartridge 20 may be mounted in the recess 15 and provide insect repellant that may be vaporized and distributed by the device 10.

In embodiments, the body 12, 212 may include at least one printed circuit board 30 (see FIGS. 4 and 4A, for example). In embodiments, the printed circuit board 30 may be mounted in the body 12, 212 via a mount 32. In embodiments, the mount 32 may be positioned such that the printed circuit board 30 is connected to or positioned to interact with the power button 14 or other input device. In embodiments, the power button 14 may be positioned to interact with the circuit board 30. In embodiments, the button 14 may be electrically connected to the circuit board 30. In embodiments, a cartridge adapter 40 (see FIGS. 4, 4A for example) may be provided in the recess 15. In embodiments, the adapter 40 may include a series of threads 40a that interact with threads 20a formed on a top portion of the cartridge 20 to releasably secure the cartridge 20 in the body 12, 212 of the device 10, 110. In embodiments, the cartridge 20 may be screwed into place in the recess 15 such that it is securely held in place. In embodiments, the cartridge 20 may be connected to the adapter 40 via any other suitable connection element or elements.

In embodiments, a heating element 50 may be provided in the body 12 above the cartridge 20 and the adapter 40. In embodiments, where the opening 113a is used, the heating element 150 may be provided above the cartridge 20 and the adaptor 40. In embodiments, one or more fasteners, such as screws, 50a may be used to secure the heating element 50 in place. In embodiments, the heating element 150 may be held in place via one or more fasteners 150a, as illustrated in FIG. 4A, for example. In embodiments, the heating element 50, 150 may surround a wick 20c extending out the top of the cartridge 20. In embodiments, the wick 20c extends into the cartridge 20 and is in contact with the insect repellent stored therein. In embodiments, the repellant may travel up the wick 20c and out of the cartridge 20. In embodiments, a seal 20b may be positioned in an open top of the cartridge 20 and provide a seal around the wick 20c to prevent repellant from leaking out of the cartridge around the wick. In embodiments, the heating element 50, 150 may be electrically connected to the printed circuit board 30 and may be selectively activated to heat the wick 20c. In embodiments, a control circuit may be provided on the printed circuit board 30 and electrically connected to the heating element 50, 150 to selectively activate the heating element. In embodiments, the control circuit may be provided elsewhere in the body 12, 112. In embodiments, when the heating element 50, 150 is activated, it heats the wick 20c and vaporizes the insect repellant in the wick to provide a cloud of vaporized repellant. In embodiments, the vaporized repellant escapes out of the vent openings 114 and surrounds the device 10 to provide an insect free zone. In embodiments, the vent openings 114 may be provided in the side of the body 12 to encourage dispersal of the vaporized repellant laterally around the device 10. In embodiments, where the opening 113a is used, the vaporized repellant may pass through the internal passage P and through or around the mesh or screen 113b and out of the top of the device 110.

In embodiments, one or more movable posts 70a may be mounted in the body 12, 212 such that they are movable from an open position when the cartridge 20 is not mounted in the recess 15, to a closed position when the cartridge is mounted in the recess. In the closed position, the posts 70a are pressed inward toward electrical contacts 70b. When the posts 70a come into contact with the electrical contacts 70b, the heating element 50, 150 may be activated. While the posts 70a are in the open position, the heating element 50, 150 cannot be activated such that the heating element only gets hot when it is shielded by the presence of the cartridge 20. In embodiments, the posts 70a are biased into the open position using biasing elements 70c, which are mounted in the biasing housings 70e. Since the heating element 50, 150 cannot be activated when the cartridge 20 is not in place, it protects user's from being burned and reduces the chance of accidental activation that may result in a fire or injury. In embodiments, a single post 70a may be used instead of the two posts.

In embodiments, the contacts 70b may be electrically connected to the printed circuit board 30 and/or to the heating element 50, 150 such that the contacts may be used to prevent activation of the heating element. In embodiments, the printed circuit board 30 may include control circuitry as discussed above, which may be connected to the heating element 50, 150 and/or to the contacts 70b and operable to control operation thereof. In embodiments, the control circuit of the printed circuit board 30 activates the heating element 50, 150 based on input provided by the button 14 as well as the position of the posts 70a. In embodiments, a user may push the button 14 to activate the heating element 50, 150. If the cartridge 20 is in place in the recess 15 such that the posts 70a are in contact with the electrical contacts 70b, the heating element 50, 150 will heat the repellant in the wick 20c and vaporize it. In embodiments, when the posts 70a are in the open position, even if the button 14 is pushed, the heating element 50, 150 will not be activated. In embodiments, a sensor may be used to detect a position of the posts 70a and the control circuit may prevent activation of the heating element 50, 150 unless the position of the posts indicated that the cartridge 20 is positioned in the body.

In embodiments, the power source 60 may be a battery. In embodiments, the power source 60 may be a rechargeable battery. In embodiments, the power source 60 may be a removable battery. In embodiments, the printed circuit board 30 may include a charging circuit or circuits electrically connected to the charging port 16 as well as to the power source 60. In embodiments, the charging circuit or circuits may be configured to control charging of the power source 60 and may be configured for electrical connection to the power source 60 and the port 16.

In embodiments, the printed circuit board need not be used and the control circuit and charging circuit may be implemented as discrete circuits. In embodiments, the control circuit and charging circuit may be implemented via a programmable logic device provided in the body 12, 112.

One advantage of the portable insect repellent vaporizer device 10, 110 is that its compact construction and portable power source allow it to be used virtually anywhere. The inclusion of the movable posts 70a in the body 12 to detect the presence of the cartridge 20 and prevent heating when the cartridge is missing provides portability while maintaining safety.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A portable insect repelling device comprises:
a body including a top portion and a bottom portion,
the top portion including an opening in fluid communication with an interior of the body;
the bottom portion including:
a bottom wall including a recess formed therein;
a cartridge adapter configured to releasably secure a cartridge including insect repellant;
a heating element positioned adjacent to the cartridge adapter;
a movable cartridge detecting element configured to contact the cartridge when the cartridge is mounted in the recess;
a power source electrically connected to the heating element and operable to selectively activate the heating element source,
wherein the heating source is activated based on a position of the cartridge detecting element.

2. The portable insect repelling device of claim 1, wherein the top portion and the bottom portion are integrated.

3. The portable insect repelling device of claim 2, wherein the top portion includes a top wall and sidewall extending downward therefrom to the bottom wall.

4. The portable insect repelling device of claim 3, wherein the opening is formed in the top wall.

5. The portable insect repelling device of claim 3, wherein the opening is formed in the sidewall.

6. The portable insect repelling device of claim 5, wherein the opening includes a plurality of slots formed in the sidewall.

7. The portable insect repelling device of claim 6, wherein the body includes four sides and the sidewalls extend from the top wall to the bottom wall on four sides of the body.

8. The portable insect repelling device of claim 7, the slots are formed in each sidewall of the four sidewalls.

9. The portable insect repelling device of claim 1, further comprising a middle portion positioned between the upper portion and the lower portion.

10. The portable insect repelling device of claim 1, wherein the lower portion includes a control circuit configured to selectively activate the heating element.

11. The portable insect repelling device of claim 10, further comprising at least one contact electrically connected to the control circuit.

12. The portable insect repellant device of claim 11, wherein the cartridge adapter includes a rod, movably mounted in the bottom portion and movable from a closed position, in which the rod is in contact with the cartridge and the at least one contact and allows an electrical connection between the power source and the heating element and an open position in which the rod is separated from the contact and prevents electrical connection between the power source and the heating element.

13. The portable insect repellant device of claim 12 including a biasing element mounted in the lower portion and configured to bias the rod in the open position.

14. The portable insect repellant device of claim 1, including an input device operably connected to the control circuit, wherein the control circuit activates the heating element based on input information provided by the input device.

15. The portable insect repelling device of claim 14, wherein the cartridge adapter includes a rod, movably mounted in the bottom portion and movable from a closed position, in which the rod is in contact with the cartridge and the at least one contact and allows an electrical connection between the power source and the heating element and an open position in which the rod is separated from the contact and prevents electrical connection between the power source and the heating element and the control circuit activates the heating element based on the input information and position of the rod.

16. The portable insect repelling device of claim 1, further comprising an indicator mounted in the body and configured to indicate activation of the heating element.

17. The portable insect repelling device of claim 1, wherein the heating element is positioned adjacent a top of the cartridge and configured to heat repellant from the cartridge to vaporize the repellant.

18. The portable insect repelling device of claim 17, further comprising a passage formed in the top portion to provide fluid communication from the cartridge to the opening which is formed in a top wall of the top portion to allow vaporized repellant to exit the housing.

19. The portable insect repelling device of claim 1, further comprising a charging circuit electrically connected to the power source and configured to recharge the power source.

20. The portable insect repelling device of claim 19, further comprising a charging port configured for connection to an external power source and electrically connected to the charging circuit.

21. The portable insect repelling device of claim 1, wherein the heating element is ring shaped and configured to receive a wick extending from a top of the cartridge to heat repellant in the wick.
